(19) United States
(12) Patent Application Publication
(10) Pub. No.: US 2014/0263716 A1
(43) Pub. Date: Sep. 18, 2014

(54) Fire Gigga Bubble

(71) Applicant: Jim Doyle, Sun Valley, CA (US)

(72) Inventor: Jim Doyle, Sun Valley, CA (US)

(21) Appl. No.: 14/211,489

(22) Filed: Mar. 14, 2014

Related U.S. Application Data
(60) Provisional application No. 61/802,080, filed on Mar. 15, 2013.

(51) Int. Cl. B05B 17/08; F23D 14/84

(52) U.S. Cl. CPC B05B 17/08; F23D 14/84
USPC 239/18

(57) ABSTRACT

A unique water display involving igniting fire is described. Water is shot into the air and fuel is dispensed in proximity thereto. The fuel is ignited and illuminates the water. The water may encompass some of the fire and fall down around it.

### CROSS REFERENCE TO RELATED APPLICATION

The application claims the benefit of U.S. Provisional Application No. 61/802,080, filed Mar. 15, 2013, the contents of which are incorporated herein by reference.

### FIELD OF THE INVENTION

The present invention generally relates to water displays, including water displays involving fire.

### BACKGROUND OF THE INVENTION

Various water displays exist, but there is an ongoing need for unique and innovative displays.

### SUMMARY OF THE INVENTION

In an aspect of the invention, unique visual effects are provided involving fire and water. For example, water may be shot upward, followed by a flammable fuel cloud. The fuel cloud may be ignited to create a fire ball which may illuminate the water. The water may also appear to be encompassing the fire ball.

### BRIEF DESCRIPTION OF THE DRAWINGS

FIG. 1 is a side view of a water and fire delivery device.

FIG. 2 is a side view of a water and fire delivery device, a fuel cloud and a water bloom.

FIG. 3 is a side view of a water bloom and a fire ball.

FIG. 4 is a side view of a water and fire delivery device.

FIG. 5 is a perspective view of a water and fire delivery device, a water bloom and a fire ball.

FIGS. 6-9 are a series of pictures showing an embodiment of the visual effect provided by the current invention.

### DETAILED DESCRIPTION OF THE PREFERRED EMBODIMENTS

The current invention is now described with reference to the figures. Components appearing in more than one figure bear the same reference numerals. Though the current invention is described with reference to water, fluids or combinations thereof may be used.

As shown in FIG. 1, water and fire delivery device 10 may include water delivery assembly 100, fuel or fire delivery assembly 200, and ignition assembly 300. As shown in FIG. 2, water delivery assembly 100 may generally emit water in an upward display 114. Fuel or fire delivery assembly 200 may provide or dispense flammable fuel 216 beneath or in close proximity to water display 114. The fuel may be provided or dispensed so as to form a fuel cloud. Ignition assembly 300 may provide ignition means for fuel 216 via igniter 302. The ignition of fuel cloud 216 while beneath or in close proximity of water display 114 may cause a fire ball 216 to illuminate the water display 114 with fire. In addition, if the water display 114 is bloom shaped, fire ball 216 may appear to be encompassed by the bloom of water display 114, providing dramatic visual effects. This is depicted in FIG. 3 and will be described in more detail in later sections.

Water delivery assembly 100 of system 10 will now be described in detail with reference to FIG. 4. As shown in FIG. 4, water delivery assembly 100 may include a base 102, an outer body 104, an input water pipe 106, an inner water pipe 108 and an output water nozzle 110. The base 102 of the water delivery assembly 100 may be anchored or otherwise attached to the bottom floor 112 of a water basin, water fountain or other bottom surface using bolts, screws, clamps or other attachment means. Water may flow into the water delivery assembly 100 through input water pipe 106. Water may then travel generally upward through the inner water pipe 108 and be emitted through output water nozzle 110. It is preferred that the water is under adequate pressure as it is emitted out of output water nozzle 110 so that it is launched into the air in the form of a water stream 114. The preferable characteristics and general shape of the emitted water stream 114 will be discussed in later sections.

While FIG. 4 depicts the water delivery assembly 100 as consisting of an input water pipe 106, an inner water pipe 108 and an output water nozzle 110, other types of water delivery assemblies 100 that provide an output water stream of preferable shape and characteristics may also be used.

The fire delivery assembly 200 will now be described with reference to FIG. 4. As shown in FIG. 4, the fire delivery assembly 200 may include a fuel container 202, an output fuel pipe 204, an input valve 206, an input fuel pipe 208, a body pipe 210 and an output nozzle 212. Fuel container 202 may be a tank or other type of container and may contain flammable fuel. It may be preferable that the flammable fuel within fuel container 202 be a pressurized gaseous fuel. Fuel container 202 may be attached to the water delivery assembly 100 using clamps 214 or other attachment means. Fuel container 202 may also not be directly attached to the water delivery assembly 100 and may be free standing or may be attached and supported by another structure.

Fuel container 202 may include an output pipe 204 that leads to an input valve 206 that may be opened to allow gaseous fuel to flow out of the fuel container 202 and into the other components of the fire delivery assembly 200, and that may be closed to disallow gaseous fuel from being released from container 202. When valve 206 is open, gaseous fuel may flow through input pipe 208 into body pipe 210 and out output nozzle 212. The dispensed fuel may form the fuel cloud 216 of FIG. 2. Once released from output nozzle 212, gaseous fuel cloud 216 may be ignited by ignition assembly 40 as discussed in later sections. Though reference is made to the dispensed fuel as being a fuel cloud, the fuel may be dispensed in other configurations such as a stream or other configuration.

Ignition assembly 300 may include an igniter 302 that may be used to ignite gaseous fuel cloud 216 released by fuel output nozzle 212. Igniter 302 may include a spark generator (not shown) that may emit sparks that may have adequate energy to ignite gaseous fuel cloud 216 that may be in close proximity to the igniter 302. Or, igniter 302 may include a pilot light (not shown) that may be switched on or off, and when switched on may ignite gaseous fuel cloud 216 that may be in close proximity to the igniter 302. Igniter 302 may also use other means to ignite gaseous fuel cloud 216.

The characteristics of water display 114 that may be emitted from output water nozzle 110 as shown in FIG. 2 and FIG. 4 will now be described. As shown in FIG. 2 and as described above, a preferable embodiment of system 10 may include a water display 114 as being in the shape of a bloom. A bloom display 114 as shown in FIG. 2 may include an upward middle stream 116 and a downward outer umbrella 118. Middle water stream 116 may be emitted out of the output water nozzle 110 in such a way that as it reaches its peak, it opens up in the form an outward bloom or umbrella 118 while falling downward. One preferred characteristic of this type of bloom display 114 is that it include a generally hollow bottom area 120 beneath and generally inside the umbrella or bloom of water 114, in which the fuel cloud 216 may collect and be somewhat trapped and contained.

It is preferred that output fuel nozzle 212 be generally located and pointed in a location that may release and direct the gaseous fuel cloud 216 into the hollow underneath area of the bloom umbrella 118 as described above.

It is also preferred that igniter 302 be located in a position that it may be in close enough proximity to the fuel cloud 216 that may be trapped in the generally hollow underneath area of the bloom umbrella 116 such that it may ignite the fuel cloud when the igniter 302 is engaged.

With the fuel cloud 216 generally contained and trapped in the generally hollow lower section of the bloom 114 and with the igniter 302 engaged, fuel cloud 216 may be ignited and fire ball 218 may be formed. In this configuration, output fuel nozzle 212 may continue to release gaseous fuel into the underneath area of the bloom umbrella 116 such that the fire ball 218 does not run out of fuel to be extinguished, but instead, is continually replenished with new gaseous fuel such that it can continue to burn.

In this configuration, and as shown in FIG. 5, fire ball 218 may appear to be somewhat encompassed by the umbrella 118 of water display 114 and may illuminate the water bloom display 114 with fire thus creating dramatic visual effects.

It should be noted that the current invention is not limited to fire balls per se, but also includes fire as it may appear in any form, e.g., flames, scatter bright spots, etc. To this end, the fuel may be dispensed in configurations other than a cloud, such as a stream, multiple separate bursts of fuel, waves of fuel or other configurations. The water may be shot into the air to correspond to or otherwise engage the configuration of dispensed fuel. In this manner, the water may appear to encompass or otherwise engage the particular configuration of dispensed fuel.

The various assemblies of system 10 may be controlled by a computer or other controller. For instance, it may be preferable that the output fuel valve 206 be controlled remotely such that it may be switched on, switched off, and may be generally adjusted to adjust the amount of gaseous fuel that may be released by fuel container 202 and thus how much gaseous fuel may be released by output fuel nozzle 212 into the fuel cloud 216 or other configuration of dispensed fuel. By controlling the flow level of gaseous fuel out of the output fuel nozzle, a continuously burning fire ball 218 may be obtained and explosions may be avoided. It may also be preferable that the input water pressure into the water delivery assembly through input water pipe 106 and the setting of output water nozzle 110 be remotely controlled to adjust the size and shape of the umbrella bloom 114, 118, or other water configuration, in order to maximize the visual effect of the system 10.

Although certain presently preferred embodiments of the invention have been described herein, it will be apparent to those skilled in the art to which the invention pertains that variations and modifications of the described embodiments may be made without departing from the spirit and scope of the invention

What is claimed is:

1. A water display, comprising
water shot into the air; and
fuel dispensed in proximity to the water;
wherein the fuel is ignited to produce fire.

2. The water display of claim 1, wherein the fire illuminates the water.

3. The water display of claim 1, wherein the water encompasses at least some of the fire.

4. The water display of claim 3, wherein the water shot into the air falls down around the fire.

5. The water display of claim 4, wherein additional fuel is dispensed in proximity to the water as the water falls down.

6. The water display of claim 1, wherein fuel is dispensed to form a fuel cloud.

7. The water display of claim 6, wherein the fuel cloud is dispensed under the water.

8. A water display, comprising:
a water delivery system that shoots water into the air;
a fuel delivery system that dispenses fuel in proximity to the water; and
an igniter to ignite the dispensed fuel.

9. The water display of claim 8, wherein the water delivery system provides a configuration of water, the fuel delivery system provides a fuel cloud under the configuration of water and the igniter ignites the dispensed fuel.

10. The water display of claim 9, wherein the configuration of water is bloom-shaped.

11. The water display of claim 9, wherein the fire illuminates the water.

12. The water display of claim 1, wherein the water encompasses at least some of the fire.

13. The water display of claim 3, wherein the water shot into the air falls down around the fire.
